(19) United States
(12) Patent Application Publication
(10) Pub. No.: US 2026/0112806 A1
(43) Pub. Date: Apr. 23, 2026

(54) COMMUNICATION DEVICE AND COMMUNICATION METHOD

(71) Applicant: HTC Corporation, Taoyuan City (TW)

(72) Inventors: Chun-Yih WU, Taoyuan City (TW); Ta-Chun PU, Taoyuan City (TW); Yen-Liang KUO, Taoyuan City (TW)

(73) Assignee: HTC Corporation, Taoyuan City (TW)

(21) Appl. No.: 18/975,867

(22) Filed: Dec. 10, 2024

(30) Foreign Application Priority Data
Oct. 21, 2024 (TW) 113139945

(51) Int. Cl. H01Q 1/24; H01Q 1/38; H01Q 19/10

(52) U.S. Cl. CPC H01Q 1/241; H01Q 1/38; H01Q 19/10

(57) ABSTRACT

A communication device includes a nonconductive carrier and a metal resonant structure. The metal resonant structure is disposed on the nonconductive carrier. The metal resonant structure includes a plurality of first metal units with relatively large sizes, a plurality of second metal units with relatively median sizes, and a plurality of third metal units with relatively small sizes. The second metal units are disposed between the first metal units and the third metal units. When the communication device receives an RF (Radio Frequency) signal, the metal resonant structure generates a reflection signal according to the RF signal.

### CROSS REFERENCE TO RELATED APPLICATIONS

This application claims priority of Taiwan Patent Application No. 113139945 filed on Oct. 21, 2024, the entirety of which is incorporated by reference herein.

### BACKGROUND OF THE INVENTION

### Field of the Invention

The invention relates to a communication device, and more particularly, to a communication device and a communication method.

### Description of the Related Art

In the field of wireless communication, signal attenuation tends to seriously degrade the communication quality of related devices. Accordingly, there is a need to propose a novel solution for solving this problem of the prior art.

### BRIEF SUMMARY OF THE INVENTION

In an exemplary embodiment, the invention is directed to a communication device that includes a nonconductive carrier and a metal resonant structure. The metal resonant structure is disposed on the nonconductive carrier. The metal resonant structure includes a plurality of first metal units with relatively large sizes, a plurality of second metal units with relatively median sizes, and a plurality of third metal units with relatively small sizes. The second metal units are disposed between the first metal units and the third metal units. When the communication device receives an RF (Radio Frequency) signal, the metal resonant structure generates a reflection signal according to the RF signal.

In some embodiments, the metal resonant structure is configured to increase the strength of the reflection signal.

In some embodiments, in response to the RF signal, the first metal units provide a first reflection angle.

In some embodiments, in response to the RF signal, the second metal units provide a second reflection angle. The second reflection angle is greater than the first reflection angle.

In some embodiments, in response to the RF signal, the third metal units provide a third reflection angle. The third reflection angle is greater than the second reflection angle.

In some embodiments, each of the first metal units substantially has a large cross-shape, each of the second metal units substantially has a median cross-shape, and each of the third metal units substantially has a small cross-shape.

In some embodiments, the communication device covers an operational frequency band from 1 GHz to 100 GHz, and the frequency of the RF signal falls within the operational frequency band.

In some embodiments, the length of each of the first metal units is from 0.4 to 0.6 wavelength of the operational frequency band.

In some embodiments, the length of each of the second metal units is from 0.3 to 0.5 wavelength of the operational frequency band.

In some embodiments, the length of each of the third metal units is from 0.1 to 0.3 wavelength of the operational frequency band.

In some embodiments, the distance between any adjacent two of the first metal units, the second metal units and the third metal units is shorter than or equal to 0.1 wavelength of the operational frequency band.

In some embodiments, the communication device is implemented with a shoulder pad, and the first metal units are closer to a head of a user than the second metal units and the third metal units.

In some embodiments, when the communication device receives the RF signal, the metal resonant structure further generates a transmission signal according to the RF signal.

In some embodiments, the communication device is implemented with a picnic mat.

In some embodiments, the communication device is implemented with a tent.

In some embodiments, the communication device is implemented with a backpack.

In another exemplary embodiment, the invention is directed to a communication method that includes the steps of: providing a nonconductive carrier; disposing a metal resonant structure on the nonconductive carrier, wherein the metal resonant structure includes a plurality of first metal units with relatively large sizes, a plurality of second metal units with relatively median sizes, and a plurality of third metal units with relatively small sizes, and wherein the second metal units are disposed between the first metal units and the third metal units; and when an RF signal is received, generating a reflection signal by the metal resonant structure according to the RF signal.

In some embodiments, the communication method further includes: in response to the RF signal, providing a first reflection angle by the first metal units.

In some embodiments, the communication method further includes: in response to the RF signal, providing a second reflection angle by the second metal units. The second reflection angle is greater than the first reflection angle.

In some embodiments, the communication method further includes: in response to the RF signal, providing a third reflection angle by the third metal units. The third reflection angle is greater than the second reflection angle.

### BRIEF DESCRIPTION OF DRAWINGS

The invention can be more fully understood by reading the subsequent detailed description and examples with references made to the accompanying drawings, wherein:

FIG. 1 is a diagram of a communication device according to an embodiment of the invention;

FIG. 2 is a diagram of a communication device and a user according to an embodiment of the invention;

FIG. 3 is a diagram of a communication device applied to an LEO satellite communication according to an embodiment of the invention;

FIG. 4A is a diagram of a metal unit according to an embodiment of the invention;

FIG. 4B is a diagram of a metal unit according to an embodiment of the invention;

FIG. 4C is a diagram of a metal unit according to an embodiment of the invention;

FIG. 4D is a diagram of a metal unit according to an embodiment of the invention;

FIG. 5A is a diagram of a metal unit according to an embodiment of the invention;

FIG. 5B is a diagram of a metal unit according to an embodiment of the invention;

FIG. 5C is a diagram of a metal unit according to an embodiment of the invention;

FIG. 5D is a diagram of a metal unit according to an embodiment of the invention;

FIG. 5E is a diagram of a metal unit according to an embodiment of the invention;

FIG. 6A is a diagram of a metal unit according to an embodiment of the invention;

FIG. 6B is a diagram of a metal unit according to an embodiment of the invention;

FIG. 6C is a diagram of a metal unit according to an embodiment of the invention;

FIG. 7A is a diagram of a metal unit according to an embodiment of the invention;

FIG. 7B is a diagram of a metal unit according to an embodiment of the invention;

FIG. 7C is a diagram of a metal unit according to an embodiment of the invention;

FIG. 8A is a diagram of a communication device according to an embodiment of the invention;

FIG. 8B is a diagram of a communication device according to an embodiment of the invention;

FIG. 8C is a diagram of a communication device according to an embodiment of the invention;

FIG. 8D is a diagram of a communication device according to an embodiment of the invention;

FIG. 8E is a diagram of a communication device according to an embodiment of the invention;

FIG. 8F is a diagram of a communication device and a user according to an embodiment of the invention;

FIG. 8G is a diagram of a communication device according to an embodiment of the invention; and

FIG. 9 is a flowchart of a communication method according to an embodiment of the invention.

### DETAILED DESCRIPTION OF THE INVENTION

In order to illustrate the foregoing and other purposes, features and advantages of the invention, the embodiments and figures of the invention will be described in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the subject matter provided. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

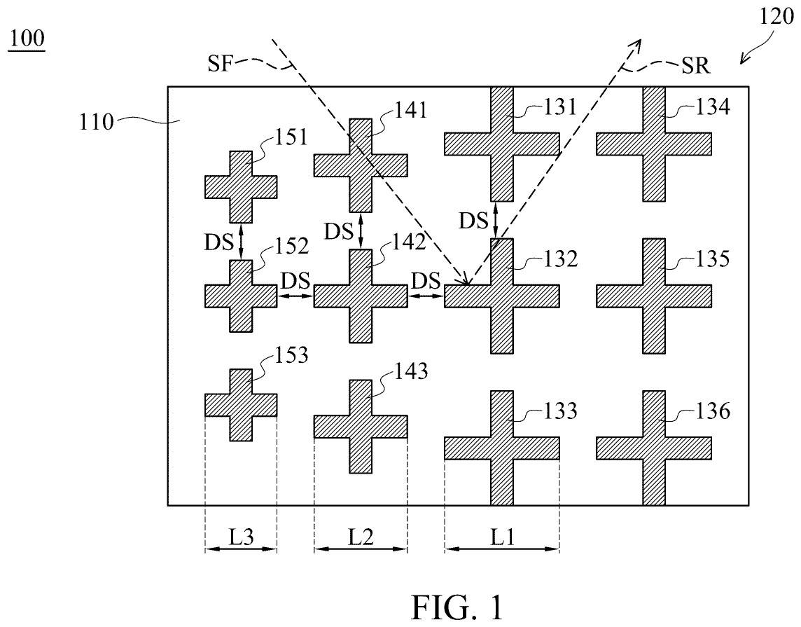

FIG. 1 is a diagram of a communication device 100 according to an embodiment of the invention. For example, the communication device 100 may be applied to related equipment of LEO (Low-Earth Orbit) satellites. Alternatively, the communication device 100 may interact with a mobile device, such as a smart phone, a tablet computer, or a notebook computer. As shown in FIG. 1, the communication device 100 at least includes a nonconductive carrier 110 and a metal resonant structure 120. It should be understood that the communication device 100 may include other components, such as a nonconductive protective film for covering the metal resonant structure 120, although they are not displayed in FIG. 1.

For example, the nonconductive carrier 110 may be implemented with a fabric element or a dielectric substrate, and its type and style may not be limited in the invention. The metal resonant structure 120 is disposed on the nonconductive carrier 110. Specifically, the metal resonant structure 120 includes a plurality of first metal units 131, 132, 133, 134, 135 and 136, a plurality of second metal units 141, 142 and 143, and a plurality of third metal units 151, 152 and 153. In some embodiments, the first metal units 131, 132, 133, 134, 135 and 136, the second metal units 141, 142 and 143, and the third metal units 151, 152 and 153 are adjacent to each other. It should be noted that the term “adjacent” or “close” over the disclosure means that the distance (spacing) between two corresponding elements is smaller than a predetermined distance (e.g., 10 mm or the shorter), but often does not mean that the two corresponding elements directly touch each other (i.e., the aforementioned distance/spacing between them is reduced to 0). That is, the first metal units 131, 132, 133, 134, 135 and 136, the second metal units 141, 142 and 143, and the third metal units 151, 152 and 153 are independent of each other, and they are also separate from each other.

The first metal units 131, 132, 133, 134, 135 and 136 have relatively large sizes. For example, each of the first metal units 131, 132, 133, 134, 135 and 136 may substantially have a large cross-shape. The number of first metal units 131, 132, 133, 134, 135 and 136 is adjustable according to different requirements. In alternative embodiments, the metal resonant structure 120 includes fewer or more first metal units.

The second metal units 141, 142 and 143 have relatively median sizes. For example, each of the second metal units 141, 142 and 143 may substantially have a median cross-shape. The number of second metal units 141, 142 and 143 is adjustable according to different requirements. In alternative embodiments, the metal resonant structure 120 includes fewer or more second metal units. It should be noted that the second metal units 141, 142 and 143 are disposed between the first metal units 131, 132, 133, 134, 135 and 136 and the third metal units 151, 152 and 153.

The third metal units 151, 152 and 153 have relatively small sizes. For example, each of the third metal units 151, 152 and 153 may substantially have a small cross-shape. The number of third metal units 151, 152 and 153 is adjustable according to different requirements. In alternative embodiments, the metal resonant structure 120 includes fewer or more third metal units.

In a preferred embodiments, when the communication device 100 receives an RF signal SF, the metal resonant structure 120 can generate a reflection signal SR according to the RF signal SF. For example, the RF signal SF may be a Bluetooth signal or a Wi-Fi signal, but it is not limited thereto. According to practical measurements, the metal resonant structure 120 is configured to increase the strength of the reflection signal SR. With such a design, even if the RF signal SF comes from a variety of directions, the metal resonant structure 120 can significantly reduce the corresponding signal attenuation, thereby effectively improving the communication quality of the reflection signal SR.

In some embodiments, the communication device 100 covers an operational frequency band. The operational frequency band may be from 1 GHz to 100 GHz. Both the frequency of the RF signal SF and the frequency of the reflection signal SR may fall within the operational frequency band. Therefore, the communication device 100 can support the wideband operations of RF wireless communication.

In some embodiments, the element sizes of the communication device 100 will be described as follows. The length L1 of each of the first metal units 131, 132, 133, 134, 135 and 136 may be from 0.4 to 0.6 wavelength (0.4λ˜0.6λ) of the operational frequency band of the communication device 100. The length L2 of each of the second metal units 141, 142 and 143 may be from 0.3 to 0.5 wavelength (0.3λ˜0.5λ) of the operational frequency band of the communication device 100. Alternatively, the length L2 of each of the second metal units 141, 142 and 143 may be from 0.31 to 0.39 wavelength (0.31λ˜0.39λ) of the operational frequency band of the communication device 100. The length L3 of each of the third metal units 151, 152 and 153 may be from 0.1 to 0.3 wavelength (0.1λ˜0.3λ) of the operational frequency band of the communication device 100. In addition, the distance DS between any two adjacent metal units selected among the first metal units 131, 132, 133, 134, 135 and 136, the second metal units 141, 142 and 143, and the third metal units 151, 152 and 153 may be shorter than or equal to 0.1 wavelength (0.1λ) of the operational frequency band of the communication device 100. The above ranges of element sizes are calculated and obtained according to many experimental results, and they help to minimize the signal attenuation of the communication device 100.

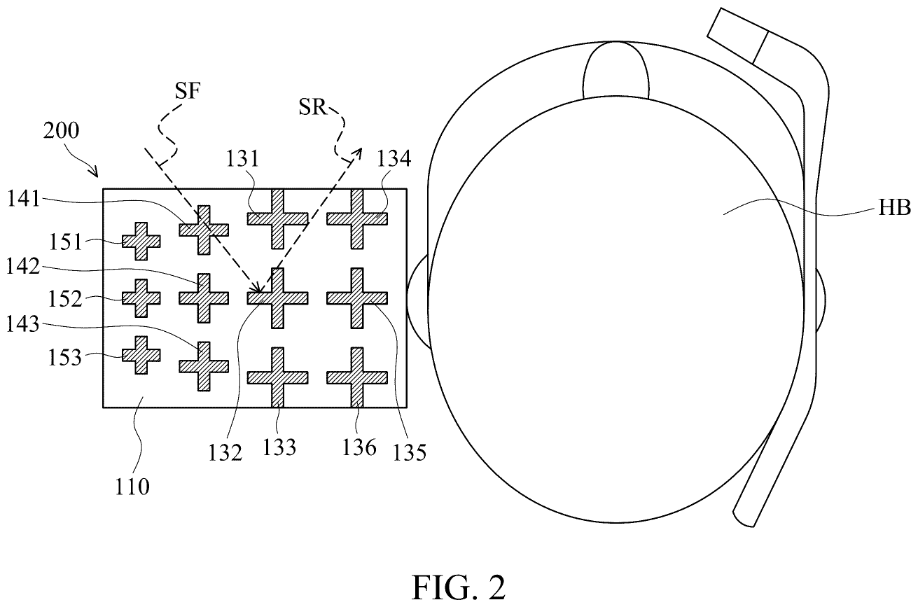

FIG. 2 is a diagram of a communication device 200 and a user HB according to an embodiment of the invention. In the embodiment of FIG. 2, the communication device 200 is implemented with a shoulder pad, and the first metal units 131, 132, 133, 134, 135 and 136 are closer to the head of the user HB than the second metal units 141, 142 and 143 and the third metal units 151, 152 and 153. According to practical measurements, even if the shoulder of the user HB has a slope and a curvature, such an arrangement can effectively avoid the deviation in the direction of propagation of the reflection signal SR. Also, the incorporation of the communication device 200 can help to maintain the sufficient strength of the reflection signal SR.

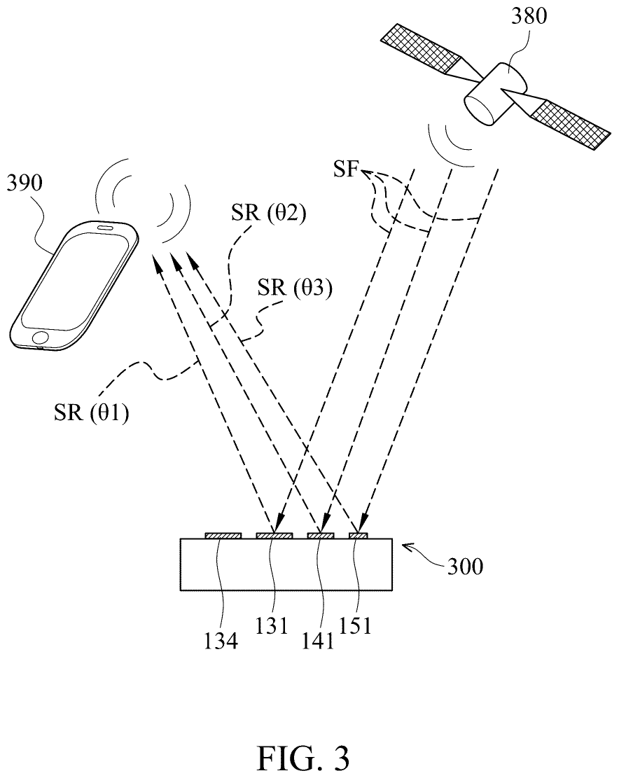

FIG. 3 is a diagram of a communication device 300 applied to the LEO satellite communication according to an embodiment of the invention. In the embodiment of FIG. 3, an LEO satellite 380 transmits an RF signal SF, and a metal resonant structure of the communication device 300 generates an reflection signal SR according to the RF signal SF, such that a mobile device 390 (e.g., a smart phone) receives and processes the reflection signal SR. It should be noted that the RF signal SF is transmitted to different positions of the metal resonant structure of the communication device 300. In response to the RF signal SF, a plurality of first metal units 131, 132, 133, 134, 135 and 136 can generate the reflection signal SR having a first reflection angle θ1, a plurality of second metal units 141, 142 and 143 can generate the reflection signal SR having a second reflection angle θ2, and a plurality of third metal units 151, 152 and 153 can generate the reflection signal SR having a third reflection angle θ3. For example, the second reflection angle θ2 may be greater than the first reflection angle θ1, and the third reflection angle θ3 may be greater than the second reflection angle θ2. According to practical measurements, such a design can provide more uniform distribution of reflection phases, so as to enhance the focus mechanism of the reflection signal SR and improve the signal strength thereof. In alternative embodiments, the communication device 300 can be applied to mobile communications, such as the communication for LTE (Long Term Evolution) or 5G (5th Generation Mobile Network).

The following embodiments will introduce different configurations and detail structural features of the communication device 100. It should be understood that these figures and descriptions are merely exemplary, rather than limitations of the invention.

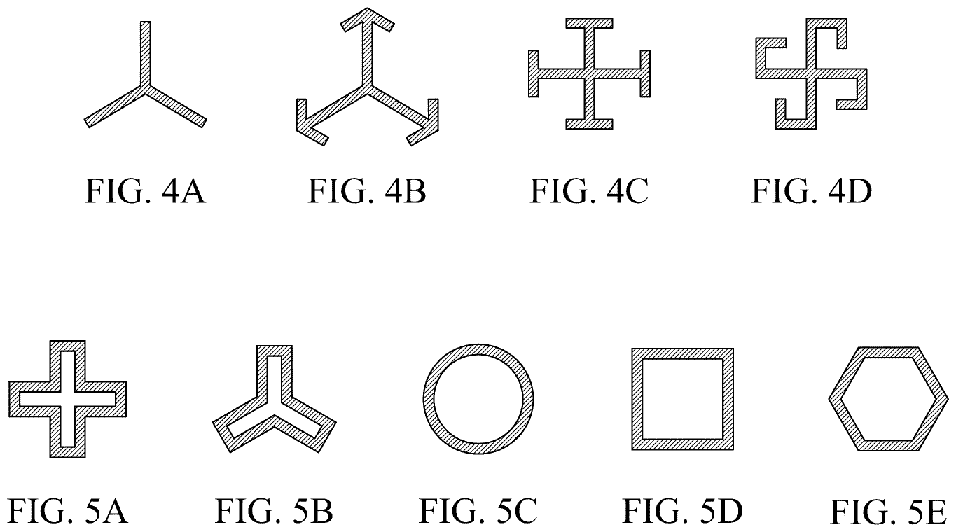

FIG. 4A is a diagram of a metal unit according to an embodiment of the invention. FIG. 4B is a diagram of a metal unit according to an embodiment of the invention. FIG. 4C is a diagram of a metal unit according to an embodiment of the invention. FIG. 4D is a diagram of a metal unit according to an embodiment of the invention. In the embodiments of FIG. 4A, FIG. 4B, FIG. 4C and FIG. 4D, each of the aforementioned metal units substantially has a Y-shape, an extended Y-shape, an extended cross-shape, or a folded cross-shape. According to practical measurements, if these metal units are applied to the communication devices 100, 200 and 300 in the previous embodiments, they will provide similar performance.

FIG. 5A is a diagram of a metal unit according to an embodiment of the invention. FIG. 5B is a diagram of a metal unit according to an embodiment of the invention. FIG. 5C is a diagram of a metal unit according to an embodiment of the invention. FIG. 5D is a diagram of a metal unit according to an embodiment of the invention. FIG. 5E is a diagram of a metal unit according to an embodiment of the invention. In the embodiments of FIG. 5A, FIG. 5B, FIG. 5C, FIG. 5D and FIG. 5E, each of the aforementioned metal units substantially has a hollow cross-shape, a hollow Y-shape, a circular ring shape, a hollow square shape, or a hollow regular hexagonal shape. According to practical measurements, if these metal units are applied to the communication devices 100, 200 and 300 in the previous embodiments, they will provide similar performance.

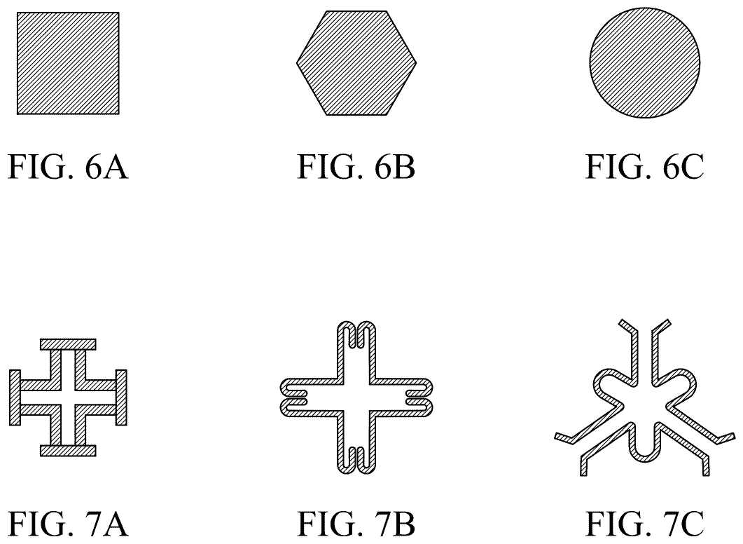

FIG. 6A is a diagram of a metal unit according to an embodiment of the invention. FIG. 6B is a diagram of a metal unit according to an embodiment of the invention. FIG. 6C is a diagram of a metal unit according to an embodiment of the invention. In the embodiments of FIG. 6A, FIG. 6B and FIG. 6C, each of the aforementioned metal units substantially has a solid square shape, a solid regular hexagonal shape, or a solid circular shape. According to practical measurements, if these metal units are applied to the communication devices 100, 200 and 300 in the previous embodiments, they will provide similar performance.

FIG. 7A is a diagram of a metal unit according to an embodiment of the invention. FIG. 7B is a diagram of a metal unit according to an embodiment of the invention. FIG. 7C is a diagram of a metal unit according to an embodiment of the invention. In the embodiments of FIG. 7A, FIG. 7B and FIG. 7C, each of the aforementioned metal units substantially has an extended hollow cross-shape, a folded hollow cross-shape, or a hybrid shape. According to practical measurements, if these metal units are applied to the communication devices 100, 200 and 300 in the previous embodiments, they will provide similar performance.

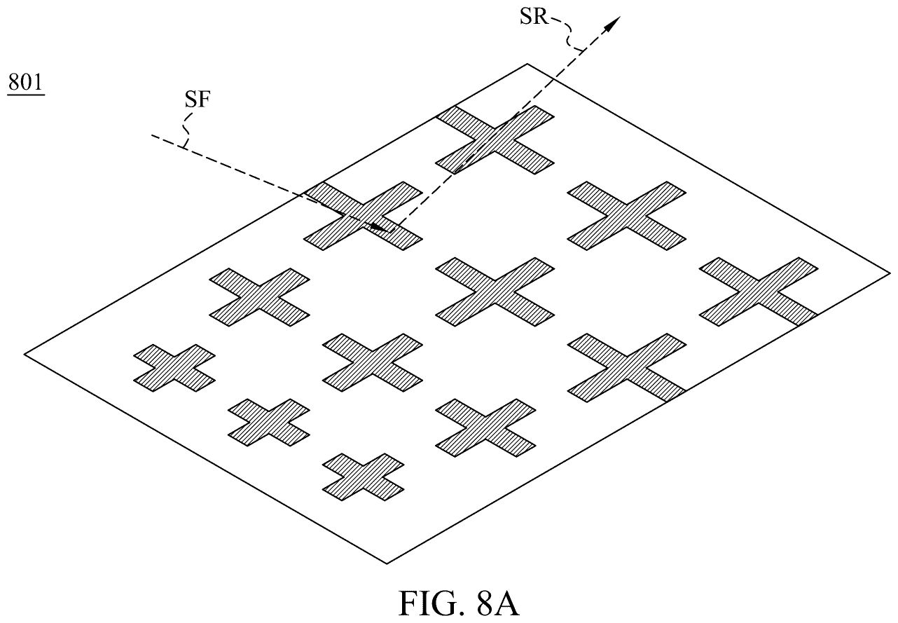

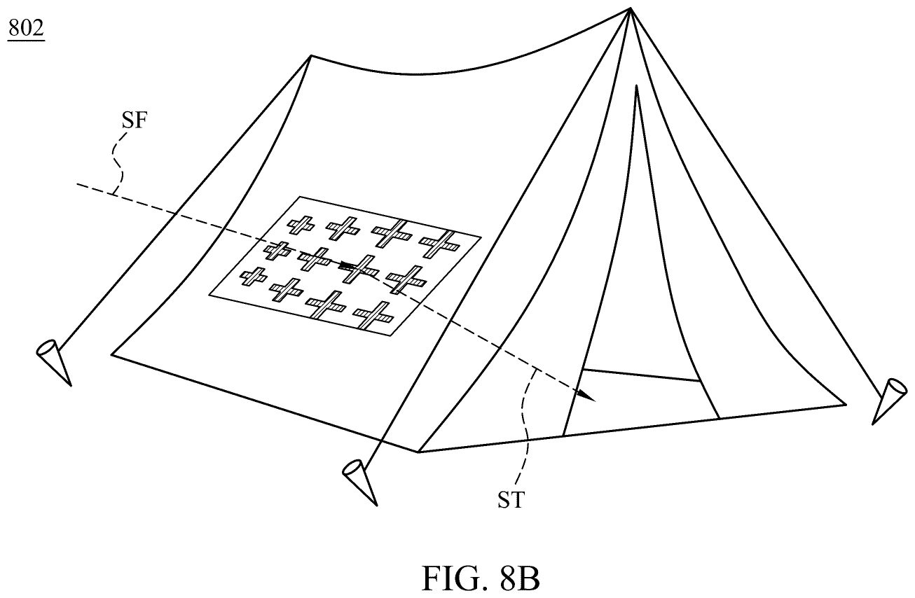

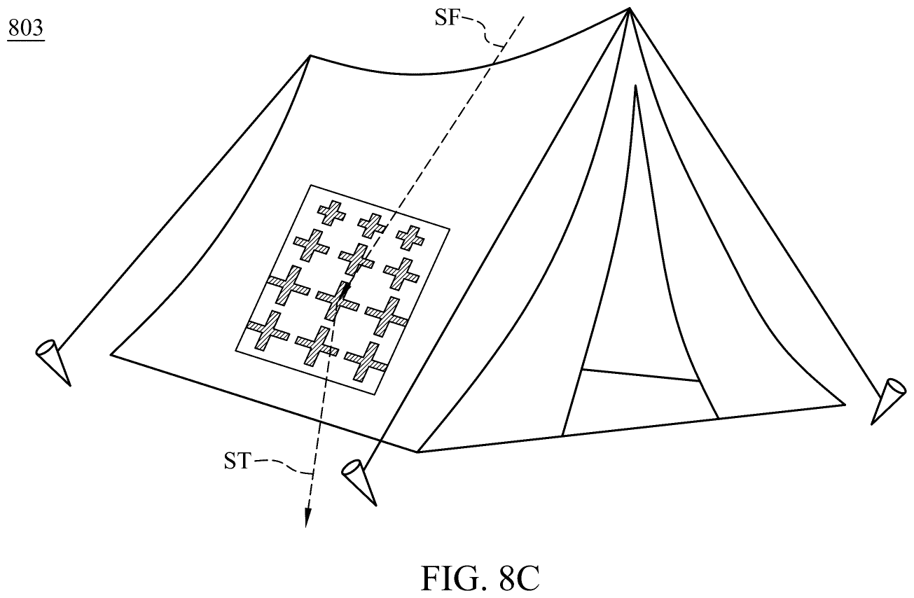

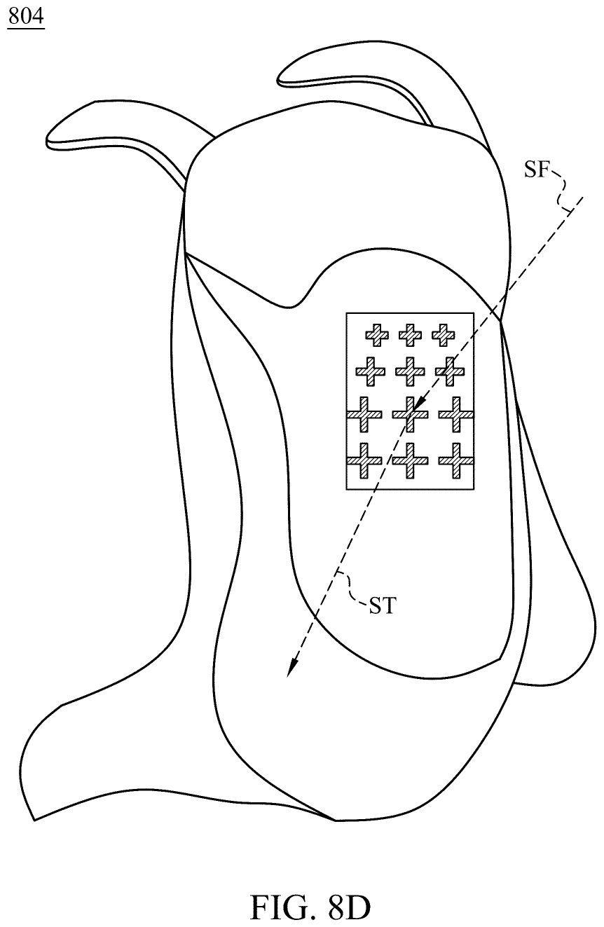

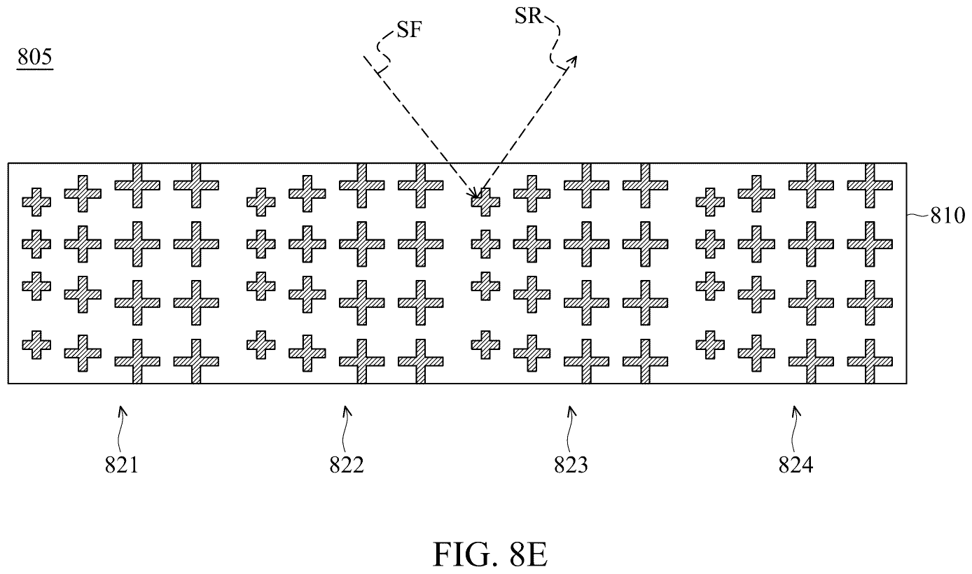

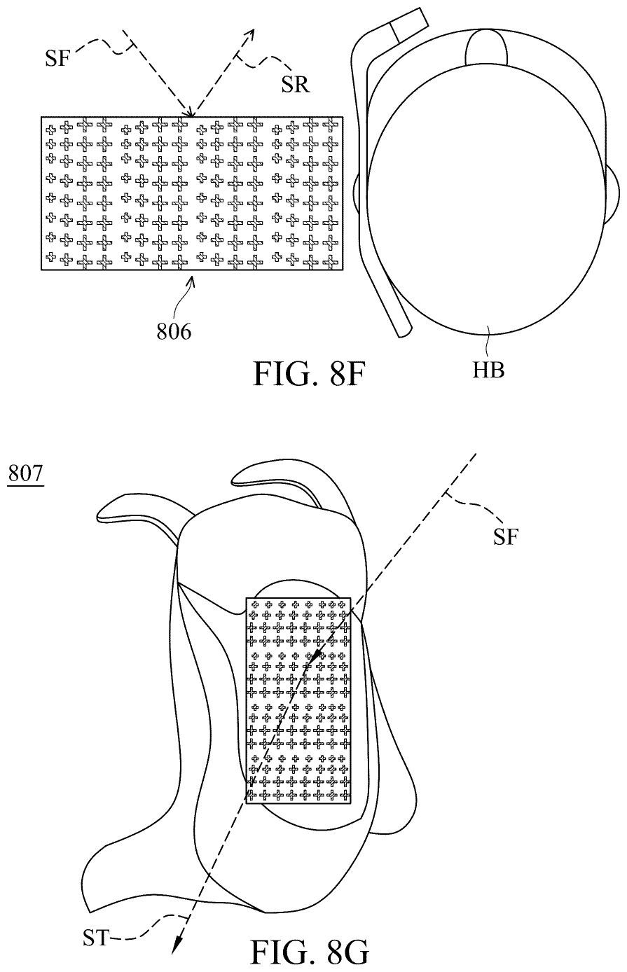

FIG. 8A is a diagram of a communication device 801 according to an embodiment of the invention. In the embodiment of FIG. 8A, the communication device 801 is implemented with a picnic mat. Similarly, when the communication device 801 receives an RF signal SF, its metal resonant structure can generate a reflection signal SR according to the RF signal SF. Thus, the communication device 801 is integrated with a daily item, and it is used to increase the strength of the reflection signal SR.

FIG. 8B is a diagram of a communication device 802 according to an embodiment of the invention. In the embodiment of FIG. 8B, the communication device 802 is implemented with a tent, and it is applied in a base-station scenario. When the communication device 802 receives an RF signal SF, its metal resonant structure can generate a transmission signal ST according to the RF signal SF. It should be understood that if the pattern of the metal resonant structure of the communication device 802 is appropriately adjusted, the strength of the transmission signal ST will be increased, and the strength of the reflection signal relative to the RF signal SF will be decreased. Thus, a mobile device disposed in the aforementioned tent (not shown) can easily receive a variety of wireless signals, such as an LEO satellite communication signal or a mobile communication signal.

FIG. 8C is a diagram of a communication device 803 according to an embodiment of the invention. In the embodiment of FIG. 8C, the communication device 803 is implemented with another tent, but it is applied in an NTN (Non-Terrestrial Network) scenario. It should be noted that in a different scenario, the arrangement direction of the metal resonant structure of the communication device 803 can be fine-tuned, so as to meet the requirements of applications.

FIG. 8D is a diagram of a communication device 804 according to an embodiment of the invention. In the embodiment of FIG. 8D, the communication device 804 is implemented with a backpack. Similarly, when the communication device 804 receives an RF signal SF, its metal resonant structure can generate a transmission signal ST according to the RF signal SF. Thus, a mobile device disposed in the aforementioned backpack (not shown) can easily receive a variety of wireless signals.

FIG. 8E is a diagram of a communication device 805 according to an embodiment of the invention. In the embodiment of FIG. 8E, the communication device 805 includes a nonconductive carrier 810 and a plurality of metal resonant structures 821, 822, 823 and 824. The metal resonant structures 821, 822, 823 and 824 may be substantially identical to each other, and they may be periodically arranged on the nonconductive carrier 810. According to practical measurements, the communication device 805 having a periodical design can further enhance the strength of the reflection signal SR in response to the RF signal SF.

FIG. 8F is a diagram of a communication device 806 and a user HB according to an embodiment of the invention. According to practical measurements, in the embodiment of FIG. 8F, the communication device 806 having a periodical design can further avoid the deviation in the direction of propagation of the reflection signal SR, and it can also maintain the sufficient strength of the reflection signal SR.

FIG. 8G is a diagram of a communication device 807 according to an embodiment of the invention. In the embodiment of FIG. 8G, the communication device 807 having a periodical design is implemented with another backpack, and it provides better performance.

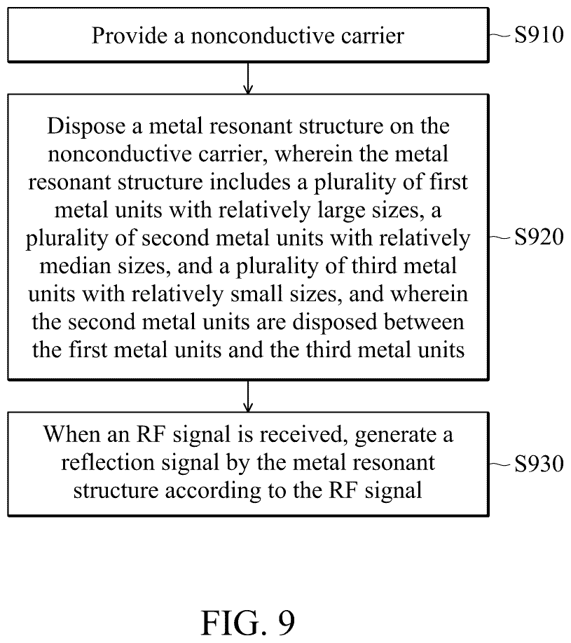

FIG. 9 is a flowchart of a communication method according to an embodiment of the invention. To begin, in step S910, a nonconductive carrier is provided. In step S920, a metal resonant structure is disposed on the nonconductive carrier. The metal resonant structure includes a plurality of first metal units with relatively large sizes, a plurality of second metal units with relatively median sizes, and a plurality of third metal units with relatively small sizes. The second metal units are disposed between the first metal units and the third metal units. Finally, in step S930, when an RF signal is received, a reflection signal is generated by the metal resonant structure according to the RF signal. It should be understood that these steps are not required to be performed in order, and every feature of the embodiments of FIGS. 1-8 may be applied to the communication method of FIG. 9.

The invention proposes a novel communication device and a novel communication method. In comparison to the conventional design, the invention has at least the advantages of reducing the signal attenuation and improving the communication quality. Therefore, the invention is suitable for application in a variety of devices.

Note that the above element sizes and element parameters are not limitations of the invention. A designer can fine-tune these setting values according to different requirements. It should be understood that the communication device and the communication method of the invention are not limited to the configurations of FIGS. 1-9. The invention may include any one or more features of any one or more embodiments of FIGS. 1-9. In other words, not all of the features displayed in the figures should be implemented in the communication device and the communication method of the invention.

The method of the invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A communication device, comprising:
a nonconductive carrier; and
a metal resonant structure, disposed on the nonconductive carrier, wherein the metal resonant structure comprises:
a plurality of first metal units, having relatively large sizes;
a plurality of second metal units, having relatively median sizes; and
a plurality of third metal units, having relatively small sizes, wherein the second metal units are disposed between the first metal units and the third metal units;
wherein when the communication device receives an RF (Radio Frequency) signal, the metal resonant structure generates a reflection signal according to the RF signal.

2. The communication device as claimed in claim 1, wherein the metal resonant structure is configured to increase a strength of the reflection signal.

3. The communication device as claimed in claim 1, wherein in response to the RF signal, the first metal units provide a first reflection angle.

4. The communication device as claimed in claim 3, wherein in response to the RF signal, the second metal units provide a second reflection angle, and the second reflection angle is greater than the first reflection angle.

5. The communication device as claimed in claim 4, wherein in response to the RF signal, the third metal units provide a third reflection angle, and the third reflection angle is greater than the second reflection angle.

6. The communication device as claimed in claim 1, wherein each of the first metal units substantially has a large cross-shape, each of the second metal units substantially has a median cross-shape, and each of the third metal units substantially has a small cross-shape.

7. The communication device as claimed in claim 1, wherein the communication device covers an operational frequency band from 1 GHz to 100 GHz, and a frequency of the RF signal falls within the operational frequency band.

8. The communication device as claimed in claim 7, wherein a length of each of the first metal units is from 0.4 to 0.6 wavelength of the operational frequency band.

9. The communication device as claimed in claim 7, wherein a length of each of the second metal units is from 0.3 to 0.5 wavelength of the operational frequency band.

10. The communication device as claimed in claim 7, wherein a length of each of the third metal units is from 0.1 to 0.3 wavelength of the operational frequency band.

11. The communication device as claimed in claim 7, wherein a distance between any adjacent two of the first metal units, the second metal units and the third metal units is shorter than or equal to 0.1 wavelength of the operational frequency band.

12. The communication device as claimed in claim 1, wherein the communication device is implemented with a shoulder pad, and the first metal units are closer to a head of a user than the second metal units and the third metal units.

13. The communication device as claimed in claim 1, wherein when the communication device receives the RF signal, the metal resonant structure further generates a transmission signal according to the RF signal.

14. The communication device as claimed in claim 1, wherein the communication device is implemented with a picnic mat.

15. The communication device as claimed in claim 1, wherein the communication device is implemented with a tent.

16. The communication device as claimed in claim 1, wherein the communication device is implemented with a backpack.

17. A communication method, comprising the steps of:
providing a nonconductive carrier;
disposing a metal resonant structure on the nonconductive carrier, wherein the metal resonant structure comprises a plurality of first metal units with relatively large sizes, a plurality of second metal units with relatively median sizes, and a plurality of third metal units with relatively small sizes, and wherein the second metal units are disposed between the first metal units and the third metal units; and
when an RF signal is received, generating a reflection signal by the metal resonant structure according to the RF signal.

18. The communication method as claimed in claim 17, further comprising:
in response to the RF signal, providing a first reflection angle by the first metal units.

19. The communication method as claimed in claim 18, further comprising:
in response to the RF signal, providing a second reflection angle by the second metal units, wherein the second reflection angle is greater than the first reflection angle.

20. The communication method as claimed in claim 19, further comprising:
in response to the RF signal, providing a third reflection angle by the third metal units, wherein the third reflection angle is greater than the second reflection angle.
